(19) United States
(12) Patent Application Publication
(10) Pub. No.: US 2025/0167561 A1
(43) Pub. Date: May 22, 2025

(54) Battery Management and Optimization Using Voice Integration Systems

(71) Applicant: Google LLC, Mountain View, CA (US)

(72) Inventors: Bonnie Yip, San Francisco, CA (US); James Robert Lim, Mountain View, CA (US)

(73) Assignee: Google LLC, Mountain View, CA (US)

(21) Appl. No.: 18/842,219

(22) PCT Filed: May 3, 2022
(86) PCT No.: PCT/US2022/072078

§ 371 Date: Aug. 28, 2024

(51) Int. Cl. H02J 7/00; G06F 3/16

(52) U.S. Cl. CPC H02J 7/00032; G06F 3/167; H02J 7/0048

(57) ABSTRACT

The present document describes systems and techniques for battery management and optimization using voice integration systems. These techniques include one or more electronic devices defining a voice integration system and having connectivity to a server system. These devices are configured to provide audio data relating to battery operations, including battery charging, to a user of an electronic device. Further, these techniques enable the user of the electronic device to provide additional audio data to the voice integration system and, thereby, instruct the server system to perform one or more actions relating to battery operations associated with the electronic device. In this way, the user can manage and optimize battery operations using the voice integration system.

### BACKGROUND

Electronic devices continue to make significant contributions to modern society, such as in the realms of safety, transportation, communication, and more, propelling their integration into the daily lives of users. Unfortunately, many users have difficulty tangibly operating electronic devices. For instance, some users are physically handicapped, while other users experience impediments while navigating operating systems of electronic devices due to a lack of familiarity. As a result, such users may experience many legitimate psychological feelings including frustration, inadequacy, and fear of missing out (“FOMO”). Lacking the ability to manage and optimize one's personal property, including electronic devices, in a familiar way can often be upsetting. Moreover, being uninformed of preferred practices when operating these electronic devices can lead to serious consequences, including battery fires and waste.

### SUMMARY

The present document describes systems and techniques for battery management and optimization using voice integration systems. These techniques include one or more electronic devices defining a voice integration system and having connectivity to a server system. These devices are configured to provide audio data relating to battery operations, including battery charging, to a user of an electronic device. Further, these techniques enable the user of the electronic device to provide additional audio data to the voice integration system and, thereby, instruct the server system to perform one or more actions relating to battery operations associated with the electronic device. In this way, the user can manage and optimize battery operations using the voice integration system.

In some aspects, a method is disclosed that: provides, via a speaker of a voice integration system, an audio inquiry requesting audio input from the user, the audio inquiry relating to one or more charging options for a rechargeable battery of an electronic device; receives, from the user and at a microphone of the voice integration system, the requested audio input, the requested audio input indicating one or more charging including at least a desired charge level for the rechargeable battery of the electronic device; and directs, via a processor or a network communication module associated with the voice integration system and configured to communicating with at least one electronic component of the electronic device or charging unit configured to charging the rechargeable battery of the electronic device, the electronic device or the charging unit configured to charging the rechargeable battery of the electronic device to charge the rechargeable battery of the electronic device to the desired charge level indicated by the requested audio input.

This document also describes computer-readable media having instructions for performing the above-summarized methods and other methods set forth herein, as well as systems and means for performing these methods.

This summary is provided to introduce simplified concepts of battery management and optimization using voice integration systems, which are further described below in the Detailed Description. This summary is not intended to identify essential features of the claimed subject matter, nor is it intended for use in determining the scope of the claimed subject matter.

### BRIEF DESCRIPTION OF THE DRAWINGS

The details of one or more aspects of battery management and optimization using voice integration systems are described in this document with reference to the following drawings. The same numbers are used throughout the drawings to reference like features and components:

FIG. 1A is a representative network environment in accordance with some implementations;

FIG. 1B illustrates the representative network environment in more detail;

FIG. 2A is a block diagram illustrating a representative network architecture that includes a home area network in accordance with some implementations;

FIG. 2B illustrates a representative operating environment in which a server system provides data processing for monitoring and facilitating review of events in video streams captured by cameras;

FIG. 3 is a block diagram illustrating the server system in accordance with some implementations;

FIG. 4 is a block diagram illustrating a representative smart device in accordance with some implementations;

FIG. 5 illustrates an example implementation of information that is associated with one or more users and is usable by a battery manager and/or a server-side module in accordance with some implementations;

FIG. 6 depicts an example method for battery management and optimization using voice integration systems in accordance with some implementations;

FIG. 7 illustrates an example implementation of battery management and optimization using voice integration systems in accordance with some implementations;

FIG. 8 illustrates another example implementation of battery management and optimization using voice integration systems in accordance with some implementations;

FIG. 9 illustrates another example implementation of battery management and optimization using voice integration systems in accordance with some implementations;

FIG. 10 illustrates another example implementation of battery management and optimization using voice integration systems in accordance with some implementations;

FIG. 11 illustrates another example implementation of battery management and optimization using voice integration systems in accordance with some implementations; and

FIG. 12 illustrates another example implementation of battery management and optimization using voice integration systems in accordance with some implementations.

### DETAILED DESCRIPTION

### Overview

The present document describes systems and techniques for battery management and optimization using voice integration systems. The techniques described herein enable users of electronic devices to procure greater degrees of knowledge, control, and assurance of rechargeable battery operability (e.g., battery state of health, charging and discharging operations).

Many users are unaware of preferred practices to sustain battery health and longevity (e.g., battery state of health) for their electronic devices. As a result, users often unknowingly establish charging habits that accelerate battery deterioration, leading to various types of battery degradation including reduced maximum charge storage capacity, diminished battery efficiency, increased charge times, greater power expenditure, and many others. In some cases, as an example, simply leaving an electronic device to charge for prolonged periods or longer than what is required to achieve a full charge (e.g., overcharging) can negatively affect battery life. In another example, charging an electronic device above a certain threshold charge level (e.g., 70%) or allowing an electronic device to discharge below a certain threshold charge level (e.g., 20%) can introduce battery impairments such as over-potential, gas formation, or accelerated aging.

Due to many users being unaware of these preferred practices, as well as many users lacking some measure of control over a charge duration and a charge rate while charging their electronic devices, electronic devices are often discarded or replaced largely due to their degraded battery. As a consequence, otherwise usable electronic devices are relegated as waste, increasing worldwide waste landfills, and harming the environment. If, however, a user continues to use their electronic device with a degraded battery, the electronic device may more frequently demand charging due to a higher self-discharge rate. Further, more energy may be expended trying to charge the degraded battery of the electronic device. Consequently, an electronic device with a degraded battery may consume more power than an electronic device with an efficient battery. On a large scale, millions of electronic devices having batteries with various degrees of degradation can increase worldwide energy expenditure.

To address these problems, the techniques described herein for battery management and optimization via voice integration systems may, on a large scale, reduce worldwide power expenditure and waste. In more detail, by informing users of battery estimates (e.g., state of health, state of charge) and best-use practices, as well as granting users the ability to manage battery operations via voice integration systems, battery usage and longevity can be optimized. Moreover, providing users convenient methods by which to access, control, or manage a battery of their electronic device, such as voice control, not only facilitates user interaction (e.g., user-input speeds, device-output speeds), but also enables more users to engage with such features. For instance, some users who are visually impaired or are physically handicapped in some fashion may normally have difficulty accessing, controlling, and navigating their electronic devices. As a result, voice integration systems configured to receive and identify voice commands can greatly assist such users.

The following discussion describes operating environments, techniques that may be employed in the operating environments, and example methods.

### Example Environment

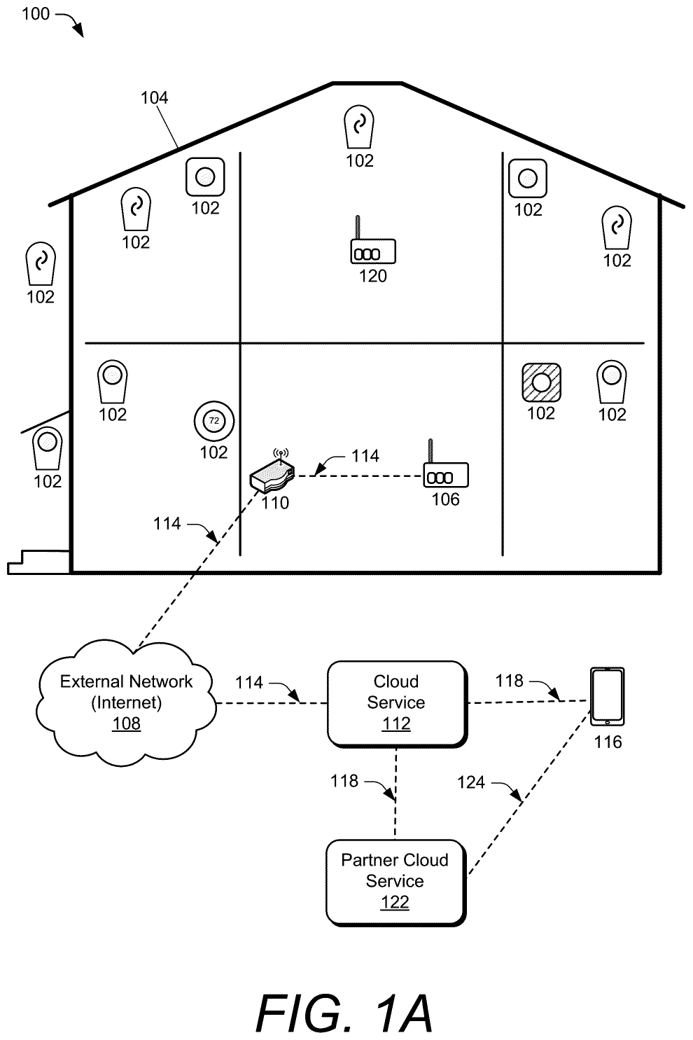

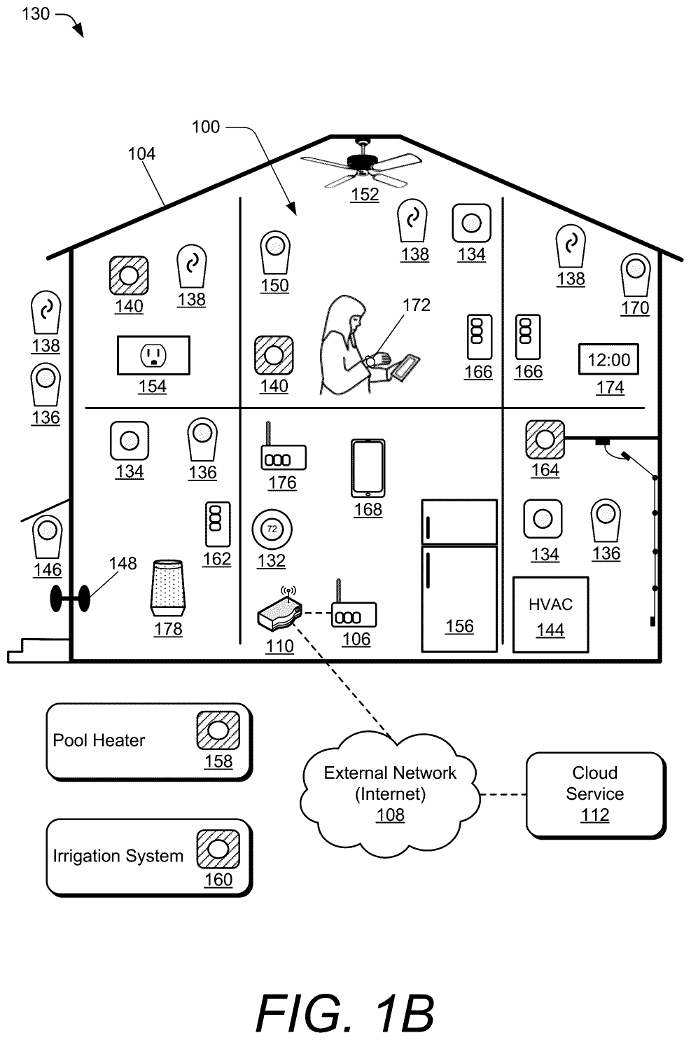

FIG. 1A illustrates an example network environment 100 in which battery management and optimization via voice integration systems can be implemented. As illustrated, a network environment 100 includes a home area network (HAN). The HAN includes one or more electronic devices, including wireless network devices 102. The wireless network devices 102 may be disposed about a structure 104, such as a house, and are connected by one or more wireless and/or wired network technologies, as described below. The HAN may include a border router 106 that connects the HAN to an external network 108, such as the Internet, through a home router or access point 110. In some implementations, wireless network devices 102 may extend beyond (e.g., outside) the structure 104 and yet still retain connectivity to the HAN or communicate to one or more devices of the HAN through the external network 108.

To provide user access to functions implemented using the wireless network devices 102 in the HAN, a cloud service 112 connects to the HAN via a border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy management hub, a heating, ventilation, and air conditioning (HVAC) hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in a distributed computing environment (e.g., the network environment 100). These services include, but are not limited to, real-time distributed data management and subscriptions, command-and-response control, real-time event notification, historical data logging and preservation, cryptographically controlled security groups, time synchronization, network and service pairing, and software updates.

FIG. 1B illustrates an example environment 130 in which a home area network, as described with reference to FIG. 1A, and aspects of battery management and optimization via voice integration systems can be implemented. Generally, the environment 130 includes the home area network (HAN) implemented as part of a home or other type of structure with any number of wireless network devices (e.g., wireless network devices 102, end-user devices 168) that are configured for communication in a wireless network. For example, the wireless network devices can include a thermostat 132, hazard detectors 134 (e.g., for smoke and/or carbon monoxide), cameras 136 (e.g., indoor and outdoor), lighting units 138 (e.g., indoor and outdoor), and any other types of wireless network devices 140 that are implemented inside and/or outside of the structure 104 (e.g., in a home environment). In this example, the wireless network devices 102 can also include any of the previously described devices, such as a border router 106, as well as a mobile device (e.g., smartphone) that may include the internet client 116.

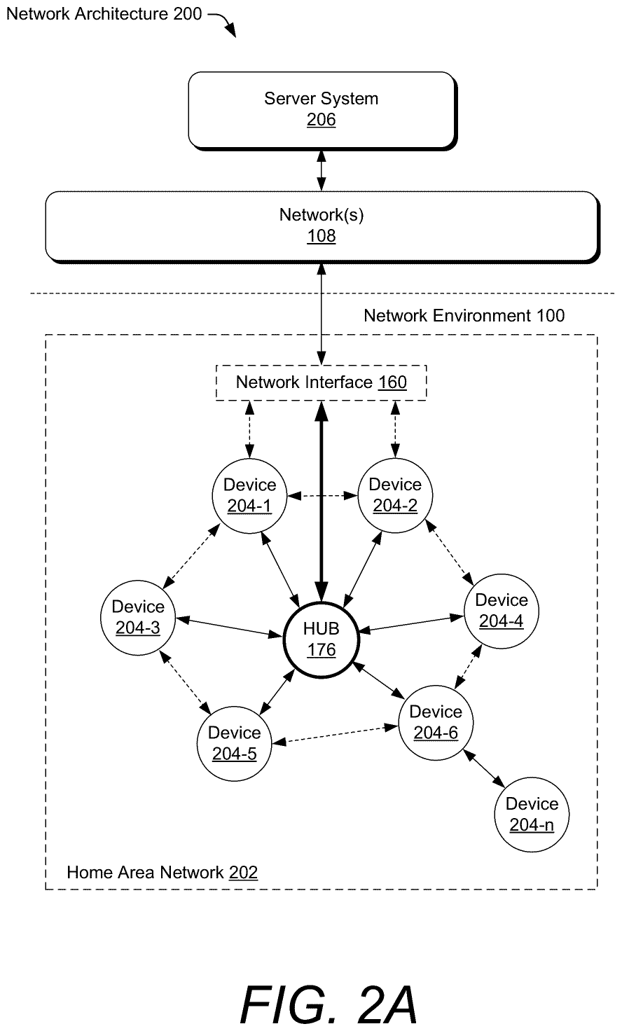

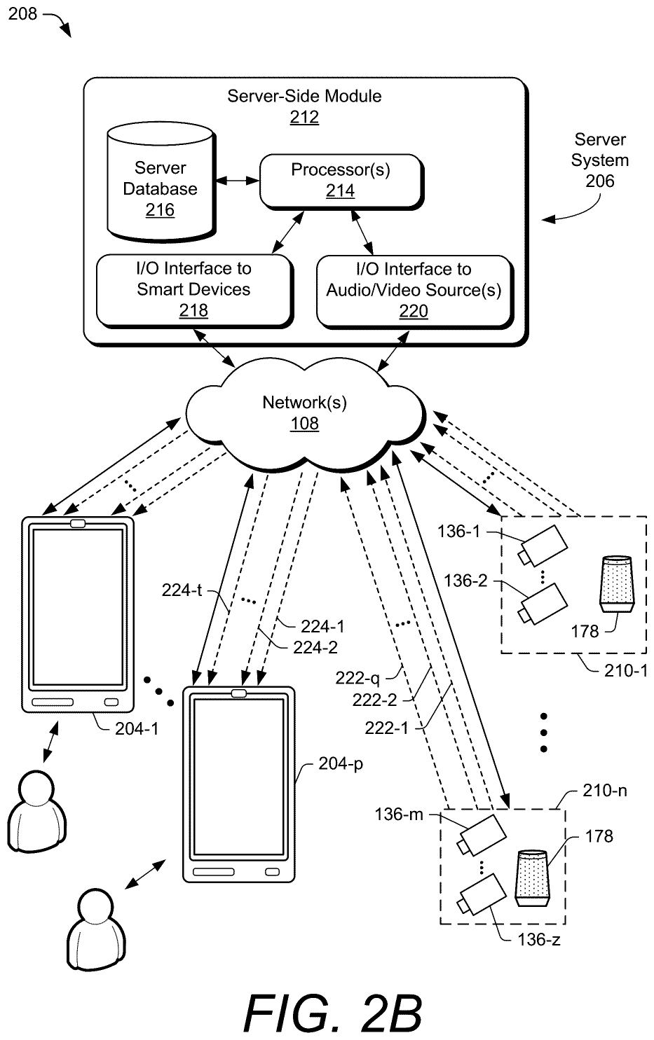

In the environment 130, any number of the wireless network devices can be implemented for wireless interconnection to wirelessly communicate and interact with each other. The wireless network devices may be modular, intelligent, multi-sensing, network-connected devices that can integrate seamlessly with each other and/or with a central server or a cloud-computing system to provide any of a variety of useful automation objectives and implementations. In an example, a first wireless network device may wirelessly communicate with a second wireless network device to exchange information therebetween. Using this wireless interconnection, the wireless network devices may exchange stored information, including information relating to one or more users, such as radar characteristics, user settings, audio data, and so forth. In addition, these wireless network devices can be communicatively coupled to other electronic devices (e.g., wired speakers, wired microphones). Furthermore, wireless network devices may exchange information regarding operations in progress (e.g., timers, music being played) to preserve a continuity of operations and/or information regarding operations across various rooms in the structure 104. These operations may be performed by one or more wireless network devices simultaneously or independently based on, for instance, the detection of a user's presence in a room. An example of a wireless network device that can be implemented as any of the devices described herein is shown and described with reference to FIG. 2A.

In implementations, the thermostat 132 may include a Nest® Learning Thermostat that detects ambient climate characteristics (e.g., temperature and/or humidity) and controls an HVAC system 144 in the home environment. The learning thermostat 132 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 134 can be implemented to detect the presence of a hazardous substance or a substance indicative of a hazardous substance (e.g., smoke, fire, or carbon monoxide). In examples of wireless interconnection, a hazard detector 134 may detect the presence of smoke, indicating a fire in the structure, in which case the hazard detector that first detects the smoke can broadcast a low-power wake-up signal to all of the connected wireless network devices. The other hazard detectors 134 can then receive the broadcast wake-up signal and initiate a high-power state for hazard detection and to receive wireless communications of alert messages. Further, the lighting units 138 can receive the broadcast wake-up signal and activate in the region of the detected hazard to illuminate and identify the problem area. In another example, the lighting units 138 may activate in one illumination color to indicate a problem area or region in the structure, such as for a detected fire or break-in, and activate in a different illumination color to indicate safe regions and/or escape routes out of the structure.

In various configurations, the wireless network devices 140 can include an entryway interface device 146 that functions in coordination with a network-connected door lock system 148, and that detects and responds to a person's approach to or departure from a location, such as an outer door of the structure 104. The entryway interface device 146 can interact with the other wireless network devices based on whether someone has approached or entered the smart home environment. An entryway interface device 146 can control doorbell functionality, announce the approach or departure of a person via audio or visual means, and control settings on a security system, such as to activate or deactivate the security system when occupants come and go. The wireless network devices 140 can also include other sensors and detectors, such as to detect ambient lighting conditions, detect room-occupancy states (e.g., with an occupancy sensor 150), and control a power and/or dim state of one or more lights. In some instances, the sensors and/or detectors may also control a power state or speed of a fan, such as a ceiling fan 152. Further, the sensors and/or detectors may detect occupancy in a room or enclosure and control the supply of power to electrical outlets 154 or devices 140, such as if a room or the structure is unoccupied.

The wireless network devices 140 may also include connected appliances and/or controlled systems 156, such as refrigerators, stoves and ovens, washers, dryers, air conditioners, pool heaters 158, irrigation systems 160, security systems 162, and so forth, as well as other electronic and computing devices, such as televisions, entertainment systems, computers, intercom systems, garage-door openers 164, ceiling fans 152, control panels 166, and the like. When plugged in, an appliance, device, or system can announce itself to the home area network as described above and can be automatically integrated with the controls and devices of the home area network, such as in the home. It should be noted that the wireless network devices 140 may include devices physically located outside of the structure, but within wireless communication range, such as a device controlling a swimming pool heater 158 or an irrigation system 160.

As described above, the HAN includes a border router 106 that interfaces for communication with an external network, outside the HAN. The border router 106 connects to an access point 110, which connects to the external network 108, such as the Internet. A cloud service 112, which is connected via the external network 108, provides services related to and/or using the devices within the HAN. By way of example, the cloud service 112 can include applications for connecting end-user devices 168, such as smartphones, tablets, and the like, to devices in the home area network, processing and presenting data acquired in the HAN to end-users, linking devices in one or more HANs to user accounts of the cloud service 112, provisioning and updating devices in the HAN, and so forth. For example, a user can control the thermostat 132 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

Any of the wireless network devices in the HAN can serve as low-power and communication nodes to create the HAN in the home environment. Individual low-power nodes of the network can regularly send out messages regarding what they are sensing, and the other low-powered nodes in the environment—in addition to sending out their own messages—can repeat the messages, thereby communicating the messages from node to node (e.g., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, the occupancy sensor 150 and/or an ambient light sensor 170 can detect an occupant in a room as well as measure the ambient light, and activate the light source when the ambient light sensor 170 detects that the room is dark and when the occupancy sensor 150 detects that someone is in the room. Further, the sensor can include a low-power wireless communication chip (e.g., an Institute of Electrical and Electronics Engineers (IEEE) 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the HAN. In other implementations, the home area network can be used to automatically turn on and off the lighting units 138 as a person transitions from room to room in the structure. For example, the wireless network devices can detect the person's movement through the structure and communicate corresponding messages via the nodes of the HAN. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 138 that lead to a safe exit. The lighting units 138 may also be turned on to indicate the direction along an exit route that a person should travel to safely exit the structure.

The various wireless network devices may also be implemented to integrate and communicate with wearable computing devices 172, such as may be used to identify and locate an occupant of the structure and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques can draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices may also include a network-connected alarm clock 174 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 132 to control the HVAC system in an efficient manner so as to pre- heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 132 so as to pre-heat or cool the environment to a desired setting and turning on or turning off the lighting units 138.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 130 may include one or more wireless network devices that function as a hub 176. The hub 176 (e.g., hub 120) may be a general-purpose home automation hub, or an application-specific hub, such as a security hub, an energy management hub, an HVAC hub, and so forth. The functionality of a hub 176 may also be integrated into any wireless network device, such as a network-connected thermostat device or the border router 106. Hosting functionality on the hub 176 in the structure 104 can improve reliability when the user's internet connection is unreliable, can reduce latency of operations that would normally have to connect to the cloud service 112, and can satisfy system and regulatory constraints around local access between wireless network devices.

Additionally, the example environment 130 includes a network-connected speaker 178. The network-connected speaker 178 provides voice assistant services that include providing voice control of network-connected devices. The functions of the hub 176 may be hosted in the network-connected speaker 178. The network-connected speaker 178 can be configured to communicate via the HAN, which may include a wireless mesh network, a Wi-Fi network, or both. In additional examples, other wireless network devices 102, including end-user devices 168, can provide voice assistant services that include providing voice control of network-connected devices.

FIG. 2A is a block diagram illustrating a representative network architecture 200 that includes a home area network 202 (HAN 202) in accordance with some implementations. In some implementations, smart devices 204 (e.g., one or more wireless network devices 102) in the network environment 100 combine with the hub 176, which may also be implemented as a smart device 204, to create a mesh network in the HAN 202. In some implementations, one or more of the smart devices 204 in the HAN 202 operate as a smart home controller. Additionally and/or alternatively, the hub 176 may operate as the smart home controller. In some implementations, a smart home controller has more computing power than other smart devices 204. The smart home controller can process inputs (e.g., from smart devices 204, end-user devices 168, and/or server system 206) and send commands (e.g., to smart devices 204 in the HAN 202) to control operation of the network environment 100. In aspects, some of the smart devices 204 in the HAN 202 (e.g., in the mesh network) are “spokesman” nodes (e.g., 204-1, 204-2) and others are “low-powered” nodes (e.g., 204-n). Some of the smart devices in the network environment 100 may be battery-powered, while others may have a regular and reliable power source, such as via line power (e.g., to 120V line voltage wires). Nodes that are typically equipped with the capability of using a wireless protocol to facilitate bidirectional communication with a variety of other devices in the network environment 100, as well as with the server system 206 (e.g., cloud service 112, partner cloud service 122) may be referred to as “spokesman” nodes. In some implementations, one or more “spokesman” nodes operate as a smart home controller. Nodes that only communicate using wireless protocols that require very little power, such as Zigbee, ZWave, 6LoWPAN, Thread, Bluetooth, etc. may be referred to herein as “low-power” nodes.

Some low-power nodes may be unconfigured to bidirectional communication. These low-power nodes send messages but are unable to “listen”. Thus, other devices in the network environment 100, such as the spokesman nodes, cannot send information to these low-power nodes. Some low-power nodes may be configured to only have limited bidirectional communication. As a result of such limited bidirectional communication, other devices may be able to communicate with these low-power nodes only during a certain time period.

As described, in some implementations, the smart devices serve as low-power and spokesman nodes to create a mesh network in the network environment 100. In some implementations, individual low-power nodes in the network environment regularly send out messages regarding what they are sensing, and the other low-powered nodes in the network environment—in addition to sending out their own messages—forward the messages, thereby causing the messages to travel from node to node (e.g., device to device) throughout the HAN 202. In some implementations, the spokesman nodes in the HAN 202, which are able to communicate using a relatively high-power communication protocol (e.g., IEEE 802.11), are able to switch to a relatively low-power communication protocol (e.g., IEEE 802.15.4) to receive these messages, translate the messages to other communication protocols, and send the translated messages to other spokesman nodes and/or the server system 206 (using, e.g., the relatively high-power communication protocol). Thus, the low-powered nodes using low-power communication protocols are able to send and/or receive messages across the entire HAN 202, as well as over the Internet (e.g., network 108) to the server system 206. In some implementations, the mesh network enables the server system 206 to regularly receive data from most or all of the smart devices in the home, make inferences based on the data, facilitate state synchronization across devices within and outside of the HAN 202, and send commands to one or more of the smart devices to perform tasks in the network environment.

As described, the spokesman nodes and some of the low-powered nodes are configured to “listening.” Accordingly, users, other devices, and/or the server system 206 may communicate control commands to the low-powered nodes. The spokesman nodes may use a low-power protocol to communicate the commands to the low-power nodes throughout the HAN 202, as well as to other spokesman nodes that did not receive the commands directly from the server system 206. In another example, a user may use the end-user device 168 (e.g., a smartphone) to send commands over the Internet to the server system 206, which then relays the commands directly back to the end-user device 168. In still further examples, a user may speak voice commands to voice integration system using the end-user device 168 (e.g., a laptop) to send commands over the HAN 202, which then relays the commands to one or more spokesman nodes in the HAN 202.

In some implementations, a lighting unit 138 (FIG. 1B), which is an example of a smart device 204, may be a low-power node. In addition to housing a light source, the lighting unit 138 may house an occupancy sensor (e.g., occupancy sensor 150), such as an ultrasonic or passive IR sensor, a proximity sensor, and an ambient light sensor (e.g., ambient light sensor 170), such as a photo resistor or a single-pixel sensor that measures light in the room. In some implementations, the lighting unit 138 is configured to activate the light source when its ambient light sensor detects that the room is dark and when its occupancy sensor detects that someone is in the room. In other implementations, the lighting unit 138 is simply configured to activate the light source when its ambient light sensor detects that the room is dark. Further, in some implementations, the lighting unit 138 includes a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly (e.g., using the mesh network) from node to node (e.g., smart device to smart device) within the HAN 202 as well as over the Internet 108 to the server system 206.

Other examples of low-power nodes include battery-operated versions of the hazard detectors 134. These hazard detectors 134 are often located in an area without access to constant and reliable power and may include any number and type of sensors, such as smoke/fire/heat sensors (e.g., thermal radiation sensors), carbon monoxide/dioxide sensors, occupancy/motion sensors, ambient light sensors, ambient temperature sensors, humidity sensors, and the like. Furthermore, hazard detectors 134 may send messages that correspond to each of the respective sensors to the other devices and/or the server system 206, such as by using the mesh network as described above.

Examples of spokesman nodes include entryway interface devices 146 (e.g., smart doorbells), thermostats 132, control panels 166, electrical outlets 154, charging unit (e.g., docking stations), and other wireless network devices 140. These devices are often located near and connected to a reliable power source, and therefore may include more power-consuming components, such as one or more communication chips configured to bidirectional communication in a variety of protocols.

In some implementations, the network environment 100 includes controlled systems 156, such as service robots, that are configured to carry out, in an autonomous manner, any of a variety of household tasks.

As explained with reference to FIG. 1B, in some implementations, the network environment 100 includes a hub device (e.g., hub 176) that is communicatively coupled to the network(s) 108 directly or via a network interface (e.g., access point 110). The hub 176 is further communicatively coupled to one or more of the smart devices 204 using a communication network (e.g., radio-frequency) that is available at least in the network environment 100. Communication protocols used by the communication network include, but are not limited to, ZigBee, Z-Wave, Insteon, EuOcean, Thread, OSIAN, Bluetooth Low Energy, and the like. In some implementations, the hub 176 not only converts the data received from each smart device to meet the data format requirements of the network interface or the network(s) 108, but also converts information received from the network interface or the network(s) 108 to meet the data format requirements of the respective communication protocol associated with a targeted smart device. In some implementations, in addition to data format conversion, the hub 176 further processes the data received from the smart devices or information received from the network interface or the network(s) 108 preliminary. For example, the hub 176 can integrate inputs from multiple sensors/connected devices (including sensors/devices of the same and/or different types), perform higher-level processing on those inputs—e.g., to assess the overall environment and coordinate operation among the different sensors/devices—and/or provide instructions to the different devices based on the collection of inputs and programmed processing. It is also noted that in some implementations, the network interface and the hub 176 are integrated into one network device. Functionality described herein is representative of particular implementations of smart devices, control application(s) running on representative electronic device(s) (such as a smartphone), hub(s) 176, and server system(s) 206 coupled to hub(s) 176 via the Internet or other Wide Area Network. All or a portion of this functionality and associated operations can be performed by any elements of the described system—for example, all or a portion of the functionality described herein as being performed by an implementation of the hub can be performed, in different system implementations, in whole or in part on the server, one or more connected smart devices and/or the control application, or different combinations thereof.

As described herein, a voice integration system may include one or more electronic devices, including smart devices 204 or other wireless network devices, and be configured to receiving audio data (e.g., voice commands via one or more microphones), transmitting streams of audio data, or commands therein, (e.g., via a network communication module), and/or providing audio output (e.g., audio data via one or more speakers). For example, a user can speak voice commands to the voice integration system using the end-user device 168 (e.g., a smartphone) to send commands over the Internet to the server system 206, which can then relay the commands to one or more spokesman nodes in the HAN 202. In some implementations, the voice integration system may include the server system 206 and/or one or more electronic devices in the HAN 202 configured to implement the techniques of the server system 206.

FIG. 2B illustrates a representative operating environment 208 in which a server system 206 provides data processing for sensed data (e.g., images, motion, audio). For example, the server system 206 can provide data processing for audio data captured by microphones (e.g., in smart devices 204, in electronic devices) or video data captured by cameras 136 (e.g., video cameras, doorbell cameras). As shown in FIG. 2B, the server system 206 receives audio/video data from audio/video sources 210 (including video cameras 136 or the network-connected speaker 178) located at various physical locations (e.g., inside or in proximity to homes, restaurants, stores, streets, parking lots, and/or the network environments 100 of FIG. 1). Each audio/video source 210 may be linked to one or more reviewer accounts, and the server system 206 provides audio/video monitoring data for the audio/video source 210 to one or more smart devices 204. For example, the portable end-user device 168 is an example of the smart device 204. In some implementations, the server system 206 is an audio processing server that provides audio processing services for audio sources and smart devices 204.

In some implementations, the server system 206 receives additional data from one or more smart devices 204 (e.g., metadata, numerical data, etc.). These data may be analyzed to provide context (e.g., actions, a power state, time, location) for audio/video data detected by video cameras 224, network-connected speaker 178, proximity sensors, motion sensors, electrical outlets 154, charging stations, or others. In some implementations, the data indicates where and at what time an audio event (e.g., detected by an audio device such as an audio sensor integrated with the network-connected speaker 178), a security event (e.g., detected by a perimeter monitoring device such as the camera 136 and/or a motion sensor), a hazard event (e.g., detected by the hazard detector 134), medical event (e.g., detected by a health-monitoring device), or the like has occurred within a network environment 100.

In some implementations, each of the audio/video sources 210 captures video or audio and sends the captured audio/video data to the server system 206 substantially in real-time. In some implementations, each of the audio/video sources 210 has its own on-board processing capabilities to perform some preliminary processing on the captured audio/video data before sending the audio/video data (e.g., along with metadata obtained through the preliminary processing) to a controller device and/or the server system 206. In some implementations, one or more of the audio/video sources 210 is configured to, optionally, locally store the video data (e.g., for later transmission if requested by a user). In some implementations, an audio/video source 210 is configured to perform some processing of the captured audio/video data and based on the processing, either send the audio/video data in substantially real-time, store the video data locally, or disregard the audio/video data.

In some implementations, the smart devices 204 communicate with a server-side module 212 executed on the server system 206 through the one or more networks 108. The server-side module 212 provides server-side functionality for data processing for any number of electronic devices, including smart devices 204 (e.g., any one of smart devices 204-1 to 204-p, any one of audio/video sources 210-1 to 210-n). In implementations, the smart devices 204 may also be implemented as audio/video sources 210. Further, one or more of the audio/video sources 210 may be a smart device 204.

In some implementations, the server system 206 includes one or more processors 214, a server database 216, an input/output (I/O) interface 218 to one or more smart devices 204, and an I/O interface 220 to one or more audio/video sources 210. The I/O interface 220 to one or more smart devices 204 facilitates the client-facing input and output processing. The I/O interface 220 to one or more audio/video sources 210 facilitates communications with one or more audio/video sources 210 (e.g., groups of one or more network-connected speakers 178, cameras 136, and associated controller devices). The server database 216 stores raw audio/video data received from the audio/video sources 210, as well as various types of metadata, such as activities, events, and categorization models, for use in data processing.

In some implementations, the server system 206 is implemented on one or more standalone data processing apparatuses or a distributed network of computers. The server system 206 may also employ various virtual devices and/or services of third-party service providers (e.g., third-party cloud service providers) to provide the underlying computing resources and/or infrastructure resources of the server system 206. In some implementations, the server system 206 includes, but is not limited to, a server computer, a handheld computer, a tablet computer, a laptop computer, a desktop computer, or a combination of any two or more of these data processing devices or other data processing devices.

The server-client environment shown in FIG. 2B includes a client-side portion (e.g., on smart devices 204, audio/video sources 210) and a server-side portion (e.g., the server-side module 212). The division of functionality between the client and server portions of an operating environment can vary in different implementations. Similarly, the division of functionality between an audio/video source 210 and the server system 206 can vary in different implementations. In some implementations, a respective one of the audio/video sources 210 is a simple audio capturing device that continuously captures and streams audio data to the server system 206 with limited or no local preliminary processing on the audio data. Although many aspects of the present technology are described from the perspective of the server system 206, the corresponding actions performed by a smart device 204 and/or the audio/video sources 210 would be apparent to one of skill in the art. Similarly, some aspects of the present technology may be described from the perspective of a smart device 204 and/or an audio/video source 210, and the corresponding actions performed by an audio/video server would be apparent to one of skill in the art. Furthermore, some aspects of the present technology may be performed by the server system 206, a smart device 204, and an audio/video source 210 cooperatively.

In some aspects, an audio/video source 210 (e.g., a video camera 136, a network- connected speaker 178) transmits one or more streams 222 of audio/video data to the server system 206. In some implementations, the one or more streams 222 include multiple streams (e.g., 222-1 through 222-q), having respective resolutions and/or rates (e.g., sample rate, frame rate), of the raw audio/video captured by an image sensor and/or microphone. In some implementations, the multiple streams include a “primary” stream (e.g., 222-1) with a certain resolution and rate, corresponding to the raw audio/video captured by the image sensor and/or microphone, and one or more additional streams (e.g., 222-2 through 222-q). An additional stream is optionally the same audio/video stream as the “primary” stream but at a different resolution and/or rate, or a stream that captures a portion of the “primary” stream (e.g., cropped) at the same or different resolution and/or rate as the “primary” stream. In some implementations, the primary stream and/or the additional streams are dynamically encoded (e.g., based on network conditions, server operating conditions, audio/video source operating conditions, characterization of data in the stream (e.g., whether motion is present), user preferences, and the like).

In some implementations, one or more of the streams 222 is sent from the video source 224 directly to a smart device 204 (e.g., without being routed to, or processed by, the server system 206). In some implementations, one or more of the streams 222 is stored at a local memory of the audio/video source 210 and/or at a local storage device (e.g., a dedicated recording device), such as a digital video recorder (DVR). For example, in accordance with some implementations, the network-connected speaker 178 stores the most-recent 24 hours of audio footage recorded by the microphone. In some implementations, portions of the one or more streams 222 are stored at the network-connected speaker 178 and/or the local storage device (e.g., portions corresponding to particular events or times of interest).

In some implementations, the server system 206 transmits one or more streams 224 of audio/video data to a smart device 204 to facilitate voice control. In some implementations, the one or more streams 224 may include multiple streams (e.g., 224-1 through 224-t), of respective resolutions and/or rates, of the same audio/video feed. In some implementations, the multiple streams include a “primary” stream (e.g., 224-1) with a certain resolution and rate, corresponding to the audio/video feed, and one or more additional streams (e.g., 224-2 through 224-t). An additional stream may be the same audio/video stream as the “primary” stream but at a different resolution and/or rate, or a stream that shows a portion of the “primary” stream (e.g., cropped to include a portion of the field of view or pixels of the primary stream) at the same or different resolution and/or rate as the “primary” stream.

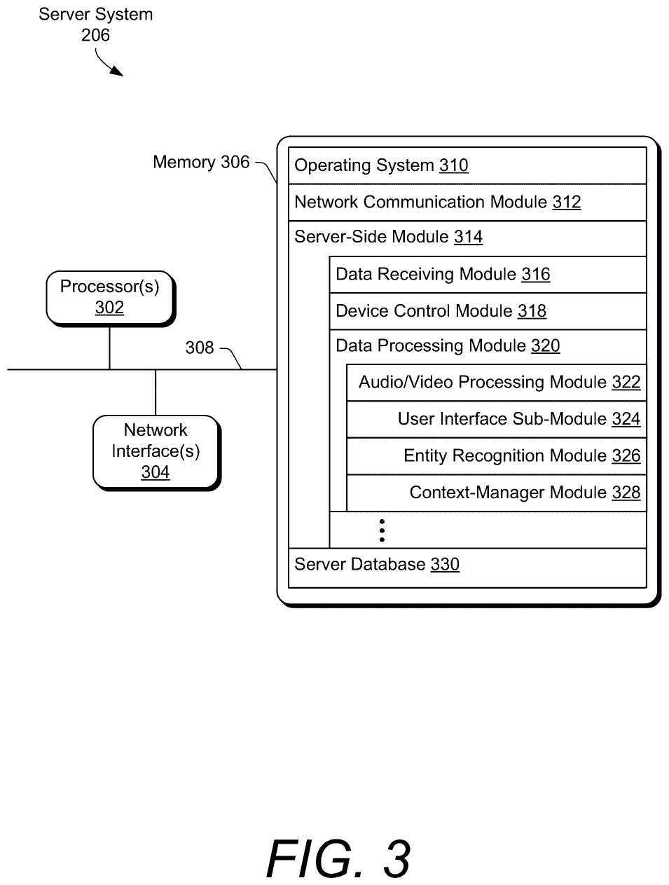

FIG. 3 is a block diagram illustrating the server system 206 in accordance with some implementations. The server system 206 typically includes one or more processors 302, one or more network interfaces 304 (e.g., including the I/O interface 218 to one or more client devices and the I/O interface 220 to one or more electronic devices), memory 306, and one or more communication buses 308 for interconnecting these components (sometimes called a chipset). The memory 306 includes high-speed random access memory, such as DRAM, SRAM, DDR SRAM, or other random access solid-state memory devices; and, optionally, includes non-volatile memory, such as one or more magnetic disk storage devices, one or more optical disk storage devices, one or more flash memory devices, or one or more other non-volatile solid-state storage devices. The memory 306, optionally, includes one or more storage devices remotely located from one or more of the processors 302. The memory 306, or alternatively the non-volatile memory within memory 306, includes a non-transitory computer-readable storage medium. In some implementations, the memory 306, or the non-transitory computer-readable storage medium of the memory 306, stores the following programs, modules, and data structures, or a subset or superset thereof:
an operating system 310 including procedures for handling various basic system services and for performing hardware dependent tasks;
a network communication module 312 for connecting the server system 206 to other systems and devices (e.g., client devices, smart devices, electronic devices, and systems connected to one or more networks 108) via one or more network interfaces 304 (wired or wireless);
a server-side module 314 (e.g., server-side module 232), which provides server-side functionalities for device control, data processing, and data review, including, but not limited to:
   a data receiving module 316 for receiving data from electronic devices (e.g., audio data from a network-connected speaker 178, FIG. 1B), and preparing the received data for further processing and storage in a server database (e.g., server database 330);
   a device control module 318 for generating and sending server-initiated control commands to modify operation modes of electronic devices (e.g., devices of a network environment 100), and/or receiving (e.g., from smart devices 204) and forwarding user-initiated control commands to modify operation modes of the electronic devices;
   a data processing module 320 for processing the data provided by the electronic devices, and/or preparing and sending processed data (e.g., commands) to a device (e.g., smart devices 204), including, but not limited to:
      an audio/video processor sub-module 322 for processing (e.g., categorizing and/or recognizing) detected voice commands within a received audio stream (e.g., an audio stream from a network-connected speaker 178);
      a user interface sub-module 324 for communicating with a user (e.g., sending alerts, charging durations, battery state of health, etc., and receiving user preferences and the like); and
      an entity recognition module 326 for analyzing and/or identifying persons detected within network environments and/or an association with one or more electronic devices;
      a context-manager module 328 for determining contexts, or estimating possible contexts, of persons detected within network environments and context-based options associated with determined or estimated contexts; and
a server database 330 for, including but not limited to:
   storing data associated with each electronic device (e.g., smart devices 204, audio/video sources 210), as well as data processing models, processed data results, and other relevant metadata (e.g., names of data results, location of electronic device, creation time, duration, settings of the electronic device, etc.) associated with the data, where (optionally) all or a portion of the data and/or processing associated with the hub 176 or smart devices are stored securely;
   storing account information for various user accounts, including user account information such as user profiles, information and settings for linked hub devices and electronic devices (e.g., hub device identifications), hub device-specific secrets, relevant user and hardware characteristics (e.g., service tier, device model, storage capacity, processing capabilities, etc.), user interface settings, data review preferences, etc., where the information for associated electronic devices includes, but is not limited to, one or more device identifiers (e.g., a media access control (MAC) address and universally unique identifier (UUID)), device-specific secrets, and displayed titles;
   storing device information related to one or more devices such as device profiles (e.g., device identifiers and hub device-specific secrets) independently of whether the corresponding hub devices have been associated with any user account;
   storing event information such as event records and context information (e.g., context-based data describing circumstances surrounding a user approaching a charging unit configured to charging an electronic device);
   storing event categorization models related to event categories for categorizing events detected by, or involving, the smart device;
   storing information regarding detected and/or recognized persons, such as audio (e.g., audio clips) of detected persons and feature characterization data for the persons; and
   use with characterizing motion, persons, and events within the network environment, e.g., in conjunction with the data processing module 320.

Each of the above-identified elements may be stored in one or more of the previously mentioned memory devices and may correspond to a set of instructions for performing a function described above. The above-identified modules or programs (e.g., sets of instructions) need not be implemented as separate software programs, procedures, or modules, and thus various subsets of these modules may be combined or otherwise rearranged in various implementations. In some implementations, the memory 306, optionally, stores a subset of the modules and data structures identified above. Furthermore, the memory 306, optionally, stores additional modules and data structures not described above.

In an example implementation, the data receiving module 316 may receive data from a network-connected speaker (e.g., network-connected speaker 178) and prepare the received data for further processing and storage in the server database. In implementations, the network-connected speaker may include a speaker, a microphone, and a network communication module, and may be configured to receive audio input via a microphone in response to, for example, an audio inquiry provided by the network-connected speaker. The audio input may be converted to a digital signal (“data”) and transmitted via the network communication module to the data receiving module 316. Upon receiving the data, the audio/video processor sub-module 322 may perform voice recognition. For example, the audio/video processor sub-module 322 may analyze and extract speech in the data. Using the extracted speech, optionally in combination with other information determined via the user interface sub-module 324, the entity recognition module 326, the context-manager module 328, and/or data stored in the server database 330, the device control module 318 generate and send server-initiated control commands, based on the extracted speech in the data, to, for example, a smartphone. The server-initiated control commands may direct an operating system, or an application, to perform any of a variety of actions, including enter a low-power mode, initiate a charging operation, cease a charging operation, etc.

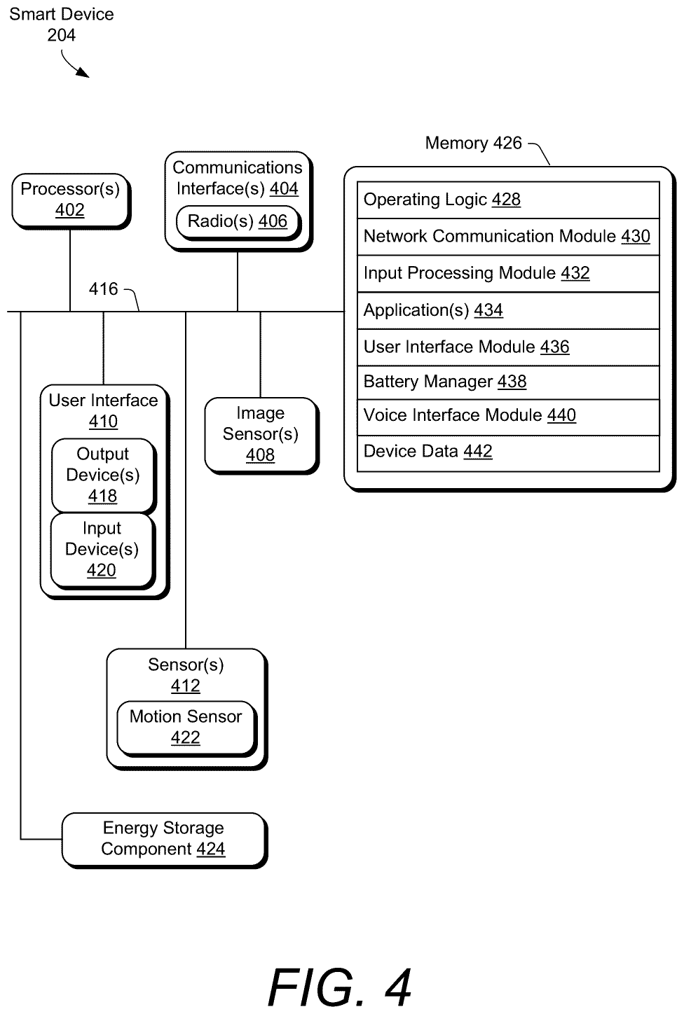

FIG. 4 is a block diagram illustrating a representative smart device 204 in accordance with some implementations. In some implementations, the smart device 204 (e.g., any device of the network environment 100 in FIG. 1) includes one or more processors 402 (e.g., CPUs, ASICs, FPGAs, microprocessors, and the like), one or more communication interfaces 404 with radios 406, image sensor(s) 408, user interface(s) 410, sensor(s) 412, memory 414, and one or more communication buses 416 for interconnecting these components (sometimes called a chipset). In some implementations, the user interface 410 includes one or more output devices 418 that enable presentation of media content, including one or more speakers and/or one or more visual displays. In some implementations, the user interface 410 includes one or more input devices 420, including user interface components that facilitate user input such as a keyboard, a mouse, a voice-command input unit or microphone, a touch screen display, a touch-sensitive input pad, a gesture capturing camera, or other input buttons or controls. In some implementations, an input device 420 for a network-connected speaker 178 is a microphone. Further, some smart devices 204, as well as some audio/video sources 210, use a microphone to input voice commands. One or more electronic devices, including smart devices 204 and audio/video sources 210, may define (e.g., collectively, individually) a voice integration system.

The sensor(s) 422 include, for example, one or more thermal radiation sensors, ambient temperature sensors, humidity sensors, infrared (IR) sensors such as passive infrared (PIR) sensors, proximity sensors, range sensors, occupancy sensors (e.g., using radio frequency identification (RFID) sensors), ambient light sensors (ALS), motion sensors 422, location sensors (e.g., GPS sensors), accelerometers, and/or gyroscopes.

In some implementations, the smart device 204 includes an energy storage component 424, including one or more batteries (e.g., a Lithium Ion rechargeable battery). In some implementations, the energy storage component 424 includes a power management integrated circuit (IC). In some implementations, the energy storage component 424 includes circuitry to harvest energy from signals received via an antenna (e.g., the radios 406) of the smart device. In some implementations, the energy storage component 424 includes circuitry to harvest thermal, vibrational, electromagnetic, and/or solar energy received by the smart device 204. In some implementations, the energy storage component 424 includes circuitry to monitor a stored energy level and adjust operation and/or generate notifications based on changes to the stored energy level.

The communication interfaces 404 include, for example, hardware configured to data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document. The radios 406 enable one or more radio communication networks in the network environments 100 and enable a smart device 204 to communicate with other devices. In some implementations, the radios 406 are configured to data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.).

The memory 426 includes high-speed random access memory (e.g., DRAM, SRAM, DDR RAM, or other random access solid-state memory devices) and, optionally, includes non-volatile memory (e.g., one or more magnetic disk storage devices, one or more optical disk storage devices, one or more flash memory devices, or one or more other non-volatile solid-state storage devices). The memory 426, or alternatively the non-volatile memory within the memory 426, includes a non-transitory computer-readable storage medium. In some implementations, the memory 426, or the non-transitory computer-readable storage medium of the memory 426, stores the following programs, modules, and data structures, or a subset or superset thereof:
operating logic 428 (e.g., an operating system) including procedures for handling various basic system services and for performing hardware dependent tasks;
a network communication module 430 for coupling to and communicating with other network devices (e.g., a network interface, such as a router that provides Internet connectivity, networked storage devices, network routing devices, a server system 206, other smart devices 204, client devices 228, etc.) connected to one or more networks 108 via one or more communication interfaces 404 (wired or wireless);
an input processing module 432 for detecting one or more user inputs or interactions from the one or more input devices 420 and interpreting the detected inputs or interactions;
one or more applications 434 for execution by the client device (e.g., games, social network applications, smart home applications, and/or other web or non-web based applications) for controlling devices (e.g., executing commands, sending commands, configuring settings, etc. to hub devices and/or other client or electronic devices) and for reviewing data captured by the devices (e.g., device status and settings, captured data, or other information regarding the hub device or other connected devices);
a user interface module 436 for providing and displaying a user interface in which settings, captured data, and/or other data for one or more devices (e.g., smart devices 204 in network environment 100) can be configured and/or viewed;
a battery manager 438 configured to access and/or determine battery statistics, including, but not limited to, a battery state of health, a battery state of charge, a projected battery life, and/or battery usage statistics, and direct one or more processors 402 to perform actions based on the battery statistics;
a voice interface module 440 configured to output audio data (e.g., an audio message) and/or receive audio data (e.g., voice commands, voice input) via a microphone, determine an action that corresponds to the audio data, and cause smart device 204, or an electronic device communicatively coupled thereto, to perform the corresponding action, including output audio data via a speaker; and
device data 442, accessible by the battery manager 438 and/or server-side module 232, for storing data associated with one or more user accounts and/or electronic devices, including, but not limited to:
   storing information related to user accounts loaded on an electronic device and electronic devices (e.g., of the audio/video sources 210) associated with the user accounts, wherein such information includes cached login credentials, hub device identifiers (e.g., MAC addresses and UUIDs), electronic device identifiers (e.g., MAC addresses and UUIDs), user interface settings, battery settings, at least some battery statistics, display preferences, authentication tokens and tags, password keys, etc.; and
   storing raw or processed data associated with electronic devices (e.g., of the audio/video sources 210, such as the network-connected speaker 178).

Each of the above-identified elements may be stored in one or more of the previously mentioned memory devices and corresponds to a set of instructions for performing a function described above. The above-identified modules or programs (e.g., sets of instructions) need not be implemented as separate software programs, procedures, or modules, and thus various subsets of these modules may be combined or otherwise rearranged in various implementations. In some implementations, the memory 426, optionally, stores a subset of the modules and data structures identified above. Furthermore, the memory 426, optionally, stores additional modules and data structures not described above, such as a sensor management module for managing operation of the sensor(s) 412. In at least some implementations, at least some techniques of the server-side module 232 may be implemented on or by the battery manager 438.

In some implementations, the voice interface module 440 is, or includes, a voice assistant (e.g., a system-specific voice assistant associated with a particular brand or type of home-automation system or a generic voice assistant that can work with a variety of home-automation systems and devices). The voice assistant may be activated by an activation word or phrase and may be configured to perform tasks as instructed by a user using voice commands.

Examples of a representative smart device 204 include a handheld computer, a wearable computing device, a personal digital assistant (PDA), a tablet computer, a laptop computer, a desktop computer, a cellular telephone, a smartphone, an enhanced general packet radio service (EGPRS) mobile phone, a media player, a navigation device, a game console, an automobile, a television, a remote control, a point-of-sale (POS) terminal, a vehicle-mounted computer, an eBook reader, or a combination of any two or more of these data processing devices or other data processing devices.

Examples of the one or more networks 108 include local area networks (LAN) and wide-area networks (WAN) such as the Internet. The one or more networks 108 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

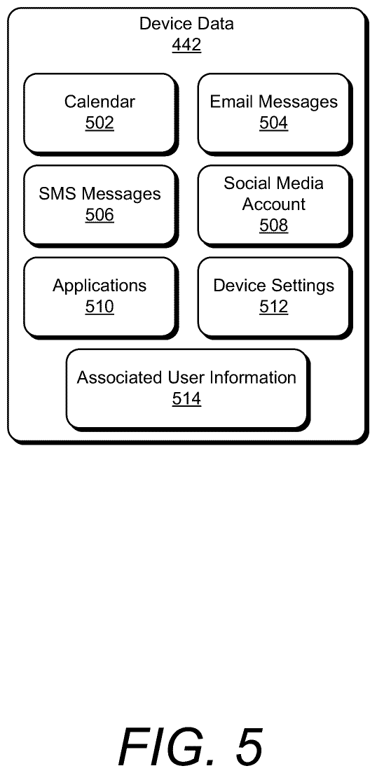

The device data 442 is described in more detail in FIG. 5, which illustrates an example implementation of information that is associated with one or more users and is usable by the battery manager 438 and/or server-side module 232. The device data 442 includes information usable to help determine, based on battery settings and/or prior user preferences, one or more of a manner in which to charge a rechargeable battery of an electronic device including a charge rate, a charge time, a charge start time, a charge finish time, a desired charge level (e.g., a state of charge level). Further, the device data 442 may include or be indicative of an identity of a user and/or an association of the user with one or more electronic devices (e.g., smart devices 204). In more detail, the device data 442 may include, or be associated with, a digital calendar 502, email messages 504, short message service (SMS) messages 506, a social media account 508, one or more applications 510 (“apps”), device settings 512, and associated user information 514.

The calendar 502 of the user may be accessible via the network 108 and may include the user's schedule of events (e.g., appointments, meetings, notifications, announcements, reminders). In aspects, the user's schedule may include information usable to predict battery-related contexts including one or more of: (i) a potential, future battery usage; (ii) an estimated duration of a scheduled event; (iii) which electronic devices a user might utilize or bring during the scheduled event; (iv) a future activity of the user; and (v) a future location of the user. For example, if the calendar 502 indicates that the user is going bird watching, then the server-side module 232 may determine that the user may utilize a digital camera.

Messages, notifications, or other communications sent or received via the user's email messages 504, SMS messages 506, social media account 508, and/or applications 510 associated with the device data 442 may be analyzed to detect whether the user is planning an unscheduled event. For example, if the user purchases airline tickets and receives an email message indicating confirmation of air travel, the context-manager module 328 can use such information to determine an event and predict battery-related contexts. In another example, the user may receive an SMS message 506 from a friend indicating that they will arrive in one hour and want to play basketball. The context- manager module 328 can use such information to determine an event and predict, for example, that a user may use a wearable computing device.

The device settings 512 include information regarding the current settings of the device such as positioning information, mode of operation information, and the like. In some implementations and instances, the device settings 512 are user-specific and are set by respective users of the device.

The associated user information 514 includes information regarding users associated with the device such as users receiving notifications from the device, users registered with the device, users associated with the network environment of the device, and the like.

### Example Methods

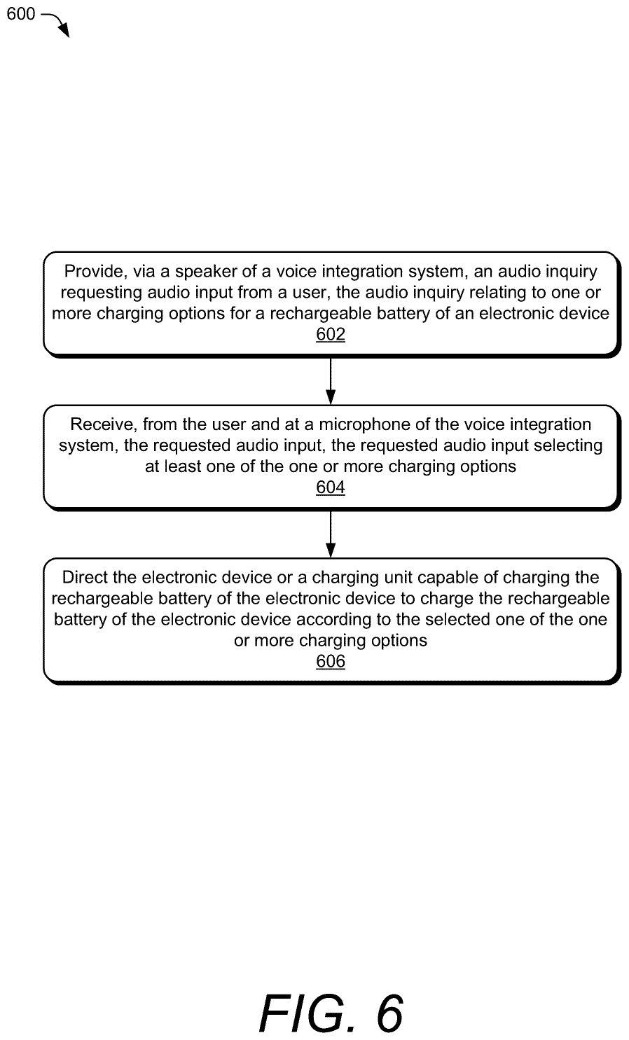

FIG. 6 depicts an example method for battery management and optimization using voice integration systems in accordance with some implementations. This method is shown as sets of blocks that specify operations performed but are not necessarily limited to the order or combinations shown for performing the operations by the respective blocks. In portions of the following discussion, reference may be made to entities or environments detailed in FIGS. 1A, 1B, 2A, 2B, 3, 4, and 5 for example only. The techniques are not limited to performance by one entity or multiple entities operating on one device.

A voice integration system and the server system 206 can cooperatively operate to perform the method 600. For example, a voice integration system including a smart device 204 (e.g., a smartphone, a hub 176) having a microphone, a speaker, and a network communication module can transmit audio data to and receive commands from the server system 206, and thereby perform the method 600. In another example, a voice integration system including a wireless network device (e.g., a smartphone) having a microphone, as well as a smart device 204 (e.g., a network-connected speaker 178) having a speaker and a network communication module, may be configured to transmit audio data to and receive commands from the server system 206, and thereby perform the method 600.

In at least some implementations, a voice integration system having one or more entities (e.g., modules) of the server system 206 can perform the method 600. For example, a voice integration system including a smart device 204 (e.g., hub 176) can include one or more entities of the server-side module 314, and thereby perform the method 600.

At 602, an audio inquiry requesting audio input from the user is provided via a speaker of the voice integration system. The audio inquiry may relate to one or more charging options for a rechargeable battery of an electronic device. In some implementations, the voice interface module 440 (e.g., a voice assistant) may provide the audio inquiry. The audio inquiry may be provided in response to or based on any of a variety of events (e.g., triggers), including an activity of a user, a direction of travel of the user, a proximity of the user to a charging unit configured to charge the electronic device, a charge level of the rechargeable battery in the electronic device, an intent of the user to charge the rechargeable battery, a schedule of the user indicative of one or more events, event locations, or event durations, etc.

For example, a radar system in one or more smart devices, such as a lightbulb, within a room can sense a proximity of a user for an extended length of time and generate data usable to determine a velocity (e.g., a direction of travel, a speed) of the user. The determined velocity may indicate that the user is traveling towards a charging unit configured to charging a rechargeable battery of a smartphone. The battery manager 438 of the smartphone may, concurrently, determine, or have recently determined, a charge level of the rechargeable battery. Both smart devices (e.g., the lightbulb and the smartphone) may transmit, via their respective network communication module 430, data relating to the user and/or device data 442 to the server system 206. Upon receiving the data relating to the user and/or the device data 442, the server-side module 314 may determine that the user may desire to charge the rechargeable battery of the smartphone after being prompted. As a result, the server system 206 may direct, via the network communication module 312, the smartphone to provide to the user, via an on-device speaker, an audio alert, warning the user that the rechargeable battery of the smartphone is below or near a first threshold charge level (e.g., 15%, 20%, 25%), which may be based on user settings, manufacturer preferred battery operating charges, etc. In further implementations, the threshold charge level may be associated with a battery state of charge at which the rechargeable battery of the smartphone experiences a greater degree (e.g., an increased rate) of degradation due to a high depth (e.g., more than 50%, more than 70%) of discharge. For example, the threshold charge level may be based on a charge level at which the rechargeable battery of the smartphone is expected (e.g., through statistical quality control) to degrade quicker than at other charge levels. In additional implementations, the server system 206 may direct, via the network communication module 312, the smartphone to provide to the user, via an on-device speaker, an audio alert, warning the user that the rechargeable battery of the smartphone is above or near a second threshold charge level (e.g., 75%, 80%, 85%), which may be based on user settings, manufacturer preferred battery operating charges, etc. In further implementations, the threshold charge level may be associated with a battery state of charge at which the rechargeable battery of the smartphone experiences a greater degree (e.g., an increased rate) of degradation due to a low depth (e.g., less than 50%, less than 70%) of discharge. Soon after providing the audio alert, or in response to the user initiating a charging sequence, the server-side module 314 may determine an intent of the user to charge the rechargeable battery of the smartphone and provide the audio inquiry requesting audio input from the user.

At 604, the requested audio input from the user may be received via a microphone of the voice integration system. The requested audio input may indicate (e.g., select) at least one of the one or more charging options. For example, the requested audio input may select a desired charge level for the rechargeable battery of the electronic device. In some implementations, the requested audio input may further select any of a desired charge start time, a desired charge finish time, a desired charge rate, or a desired charge duration.

Continuing with the previous example, the smartphone may receive the requested audio input from the user via a microphone of the smartphone. An electronic device in the HAN 202 (e.g., the smartphone, a hub 176) or the server-side module 314 (e.g., in response to the smartphone transmitting the audio data via the network communication module 430 to the server system 206) may then determine that the requested audio input indicates that the user desires to charge the electronic device to, e.g., 80%).

At 606, the electronic device, or a charging unit configured to charging the rechargeable battery of the electronic device, is directed to charge the rechargeable battery of the electronic device to the desired charge level indicated by the requested audio input. The electronic device or charging unit may be directed via at least one processor and/or a network communication module associated with the voice integration system to charge the rechargeable battery of the electronic device.

In further continuation of the previous example, the smartphone may be directed via one or more processors 402 or a network communication module (e.g., 312, 430) to cease charging after the rechargeable battery charges to, e.g., 80%. The smartphone may cease charging by using one or more on-device electronic circuits configured to gate incoming current. In some implementations, a state of charge of the rechargeable battery corresponding to the desired charge level may be determined and then the smartphone may be charged based on the state of charge corresponding to the desired charge level.

In implementations, the server system 206, or a smart device configured to implement one or more techniques of the server system 206, can receive sensor data from sensors (e.g., a passive infrared (PIR) sensor, an image capture device, a radar unit) associated with one or more devices (e.g., smart devices, electronic devices, wireless network devices) of the HAN 202, as well as device data and/or data relating to a user, and fuse the data (e.g., sensor fusion, data fusion). Using the fused data, the server system 206, or the smart device configured to implement one or more techniques of the server system 206, can, as non-limiting examples, cause one or more devices to be charged and/or suggest a charging operation for one or more devices (e.g., based on a current or future activity of a user, a current battery state of charge, a location of the user, a duration of charging) in substantially real-time. Further, the server system 206, or the smart device configured to implement one or more techniques of the server system 206, can direct one or more devices to facilitate battery discharging (e.g., draining) at any of a variety rates based on the fused data.

### Example Implementations

In some aspects, one or more electronic devices, including smart devices (e.g., smart devices 204) and/or wireless network devices (e.g., wireless network devices 102), associated with or connected to a HAN (e.g., HAN 202) may be configured to sense and generate data relating to a user, as well as device data (e.g., device data 442). Further, the data relating to the user and/or the device data, may be transmitted between devices of the HAN or a server system (e.g., server system 206) via a network communication module (e.g., network communication module 430, network communication module 312). It should be noted that one or more techniques described as being performed on or by the server system can be implementable on another electronic device associated with the HAN. Based on the data relating to the user and/or the device data, at least one entity (e.g., modules, managers, processors) may determine actions and direct the one or more electronic devices associated with or defining a voice integration system to perform the action, including audibly communicating with the user.

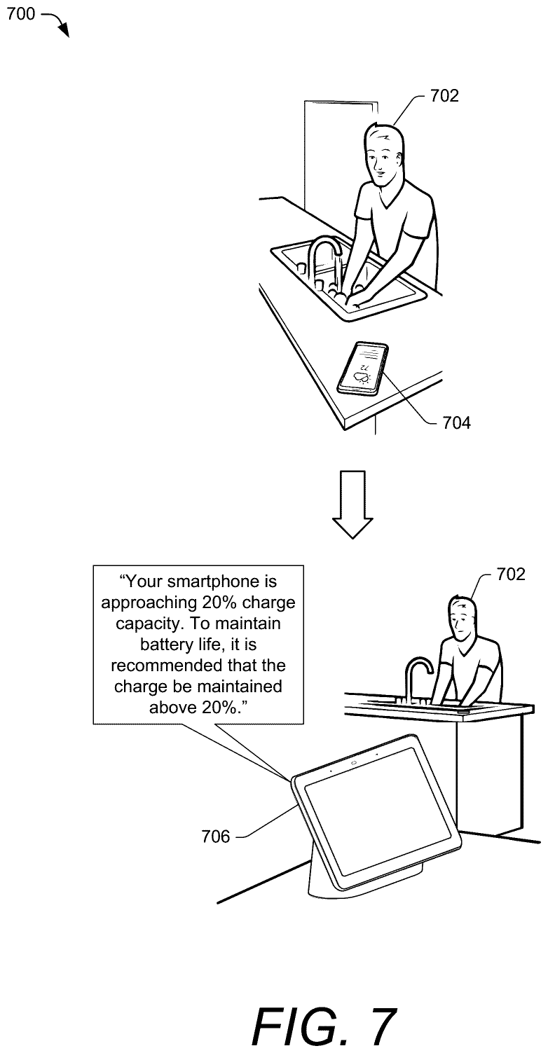

FIG. 7 illustrates an example implementation 700 of battery management and optimization using voice integration systems in accordance with some implementations. As illustrated in FIG. 7, a user 702 is looking at on-screen content (e.g., a weather forecast, a video) presented on a display of a smartphone 704. As the smartphone 704 illuminates the display to present the on-screen content, a rechargeable battery of the smartphone 704 expends electrical power, gradually decreasing a charge level of the rechargeable battery. A battery manager (e.g., battery manager 438) configured to access and/or determine battery statistics may measure the charge level of the rechargeable battery and determine whether the charge level is equivalent to, below, or approaching a threshold charge level. In one example, the battery manager may determine that the rechargeable battery of the smartphone 704 is at a charge level of 22% and approaching a threshold charge level of 20%. In response to the charge level decreasing and approaching the threshold charge level, the battery manager may direct a processor to transmit information, including instructions and/or data relating to the charge level of the rechargeable battery, to a server system.

In at least some implementations, the battery manager may direct a voice interface module (e.g., voice interface module 440) to provide an audio alert and an audio inquiry (e.g., step 602). In some cases, the user 702 may have previously defined (e.g., a user preference) a threshold charge level. In additional cases, the user 702 may have previously defined a battery setting configuring the battery manager to direct the processor to transmit information when the charge level of the rechargeable battery is decreasing at a specified rate. In additional implementations, concurrently, or at substantially similar times (e.g., within 2 minutes), electronic devices associated with the HAN, such as a wearable computing device, may transmit data relating to an identity of the user 702 or a location of the user 702 within a structure (e.g., structure 104) to the server system.

Based on at least the information originating from the battery manager, the server system, or other electronic device associated with the HAN, may analyze the information using at least one module and direct at least one electronic device associated with the voice integration system to provide the audio alert and the audio inquiry via an on-device and/or operatively coupled speaker. Additionally, based on an activity of the user 702 and/or a user preference, the server system or other electronic device associated with the HAN may direct the electronic device to perform additional actions, including dimming the display of the smartphone 704, pausing a video for a duration of the audio alert and the audio inquiry, turning off the electronic device, decreasing a volume, entering an operating mode (e.g., a low-power mode), or other actions.

As illustrated, a hub 706 (e.g., hub 176) associated with the voice integration system and the HAN, based on a received instruction from a server system, provides the audio alert and the audio inquiry to the user 702 via an on-device speaker, stating, “Your smartphone is approaching 20% charge capacity. To maintain battery life, it is recommended that the charge be maintained above 20%.” The hub 706, as opposed to other electronic devices, may have been directed to provide the audio alert and the audio inquiry based on one or more conditions, including a user preference, a proximity to a user in relation to other electronic devices, a speaker quality, an authorization, and so on. In this way, the user 702 can be audibly notified of battery best-use operations. In implementations, the audio alert may include information relating to a duration of a charging sequence (e.g., how long an electronic device has been charging).

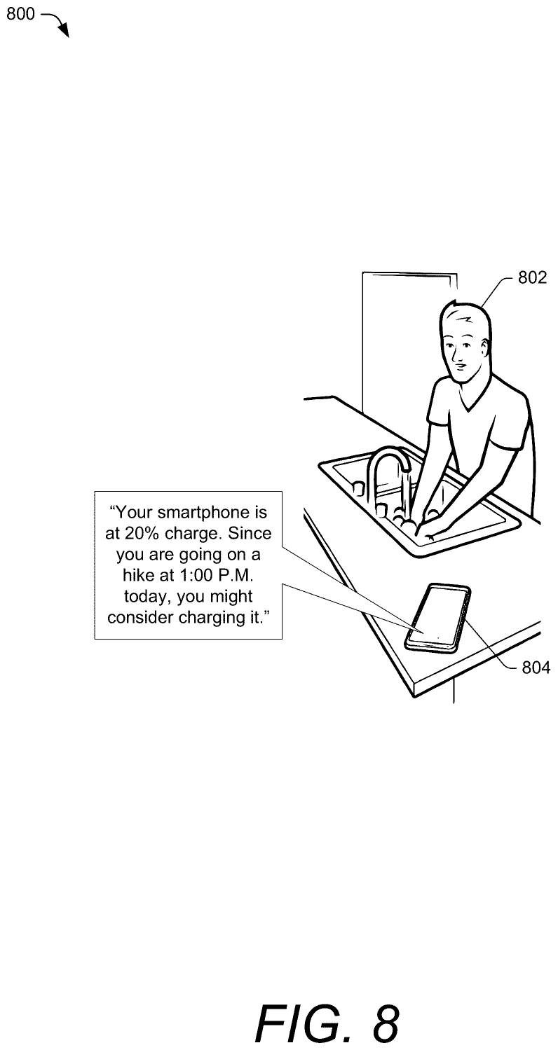

FIG. 8 illustrates another example implementation 800 of battery management and optimization using voice integration systems in accordance with some implementations. As illustrated in FIG. 8, a user 802 is performing an activity with a smartphone 804 located nearby in a low-power state (e.g., powered on but using a dark display). While in the low-power state, the smartphone 804 may be performing background operations, including maintaining connectivity to wireless networks, using a radar system to sense an environment, and so on. These background operations cause a rechargeable battery of the smartphone 804 to expend electrical power, gradually decreasing a charge level of the rechargeable battery. A battery manager configured to access and/or determine battery statistics may measure the charge level of the rechargeable battery and determine that the charge level is equivalent to, below, or approaching a threshold charge level. In response to the charge level decreasing and approaching the threshold charge level, the battery manager may direct a processor to transmit information, including instructions and/or data relating to the charge level of the rechargeable battery, to a server system.

In some implementations, the server system may also obtain device data from the smartphone 804. The device data may indicate, or be usable to determine, a schedule of a user, detailing future events, activities, locations, and durations. In additional implementations, the server system may further obtain battery usage statistics from the battery manager. The server system, using one or more modules (e.g., context-manager module 328), can analyze the device data to determine a potential, future battery usage. Based on a potential, future battery usage and a charge level of the smartphone 804, the server system can direct the smartphone 804, or any other electronic device associated with the voice integration system, to provide an audio alert. As illustrated in FIG. 8, the smartphone 804 provides an audio alert, stating, “Your smartphone is at 20% charge. Since you are going on a hike at 1:00 P.M. today, you might consider charging it.” In this way, the user can be audibly reminded and/or provided a recommendation to charge a rechargeable battery.

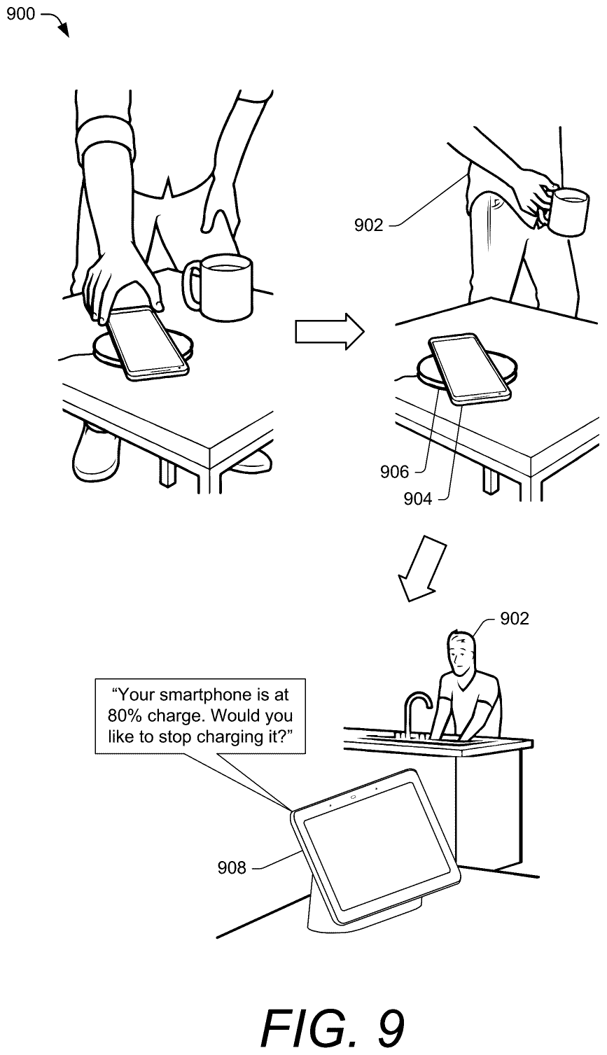

FIG. 9 illustrates another example implementation 900 of battery management and optimization using voice integration systems in accordance with some implementations. As illustrated in FIG. 9, a user 902 establishes a charging sequence by positioning a smartphone 904 on a wireless charging unit 906. While the rechargeable battery of the smartphone 904 is charging, the user 902 may perform other activities. After the smartphone 904 is charged to a threshold charge level or approaches the threshold charge level, one or more electronic devices may provide an audio alert, notifying the user 902 of the charge level for the smartphone 904, and provide an audio inquiry. As illustrated, based on a received instruction from a server system, a hub 908 associated with the voice integration system and the HAN provides the audio alert and the audio inquiry to the user 902 via an on-device speaker, stating, “Your smartphone is at 80% charge. Would you like to stop charging it?”

In some implementations, the hub 908 may be directed to provide an audio message that includes information pertaining to benefits or consequences associated with any of the one or more charging options for the rechargeable battery of the smartphone. For example, the audio message can include information regarding an increased longevity of the rechargeable battery if charged to certain charge levels. In another example, the audio message can include information regarding an increased longevity of the rechargeable battery if charged at certain charging rates.

In response to the audio inquiry, the user may provide a voice command instructing that the smartphone 904 do one of the following: be charged to 100%, cease charging, charge to another desired charge level, or perform another instruction relating to the charging of the rechargeable battery of the smartphone.

In additional implementations, the user may have previously defined, at the smartphone 904, the threshold charge level at which the voice integration system can notify him. In still further implementations, the wireless charging unit 906, an electrical outlet to the wireless charging unit 906 may be coupled to, and/or the smartphone 904 may be smart devices. Any of the smart devices may be configured to determine a charge level of the rechargeable battery of the smartphone, cease the charging, or provide the audio inquiry and audio message.

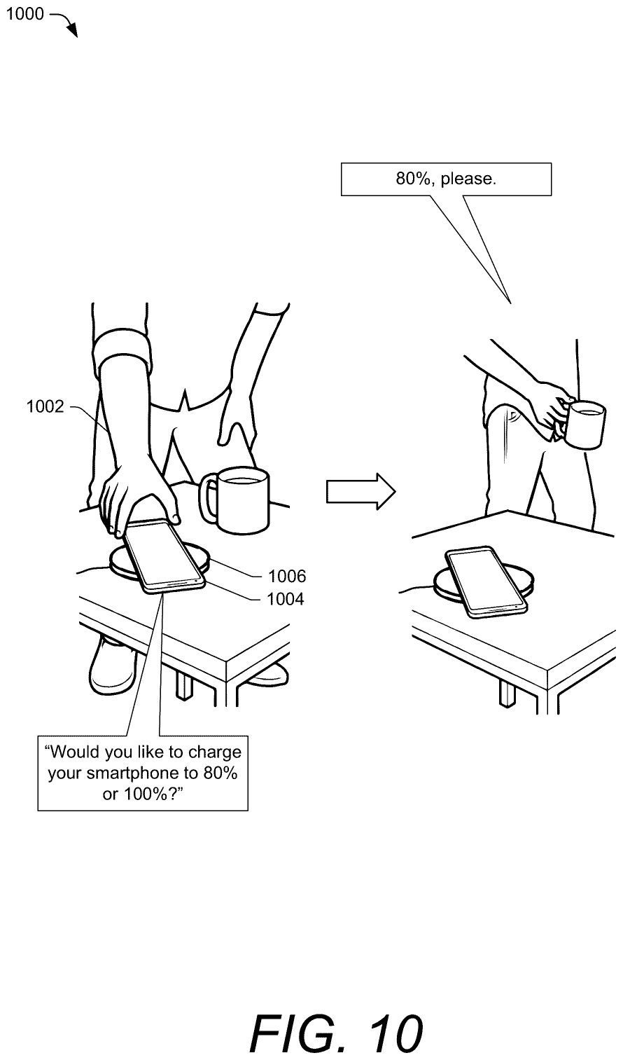

FIG. 10 illustrates another example implementation 1000 of battery management and optimization using voice integration systems in accordance with some implementations. As illustrated, a user 1002 positions a smartphone 1004 on a wireless charging unit 1006. In response, the smartphone 1004, as directed by an on-device processor implementing a voice interface module and/or the server system, provides an audio inquiry via a speaker of the smartphone 1004. The audio inquiry may ask, “Would you like to charge your smartphone to 80% or 100%?” The user 1002 may then respond to the audio inquiry with a requested audio input indicating a desired charge level for the rechargeable battery of the smartphone 1004. For example, the user 1002 may respond, “80%, please.”

A microphone of the smartphone 1004, or of any other electronic device associated with the voice integration system, can receive the requested audio input. The signal produced by the microphone, or instructions associated with the requested audio input, may then be passed to the server system. In this way, when the smartphone 1004 is charged by the wireless charging unit 1006 to the requested charge level (e.g., 80%), the server system can direct the smartphone 1004 to cease charging to preserve battery longevity.

In implementations, the server system may direct the wireless charging unit 1006 or the electrical outlet to cease charging. In still further implementations, the server system can implement steps to maintain the charge level of the rechargeable battery at 80%. For example, the server system can, based on a calculated self-discharge rate and/or battery usage statistics for a given battery operating mode, charge the rechargeable battery at a first rate before reaching the desired charge level and then at a second rate configured to maintain the charge level of the rechargeable battery at the desired charge level. In addition, the wireless charging unit and/or smartphone can be configured to indicate a charge completion (e.g., a light color change) when the rechargeable battery of the smartphone has been charged to the desired charge level.

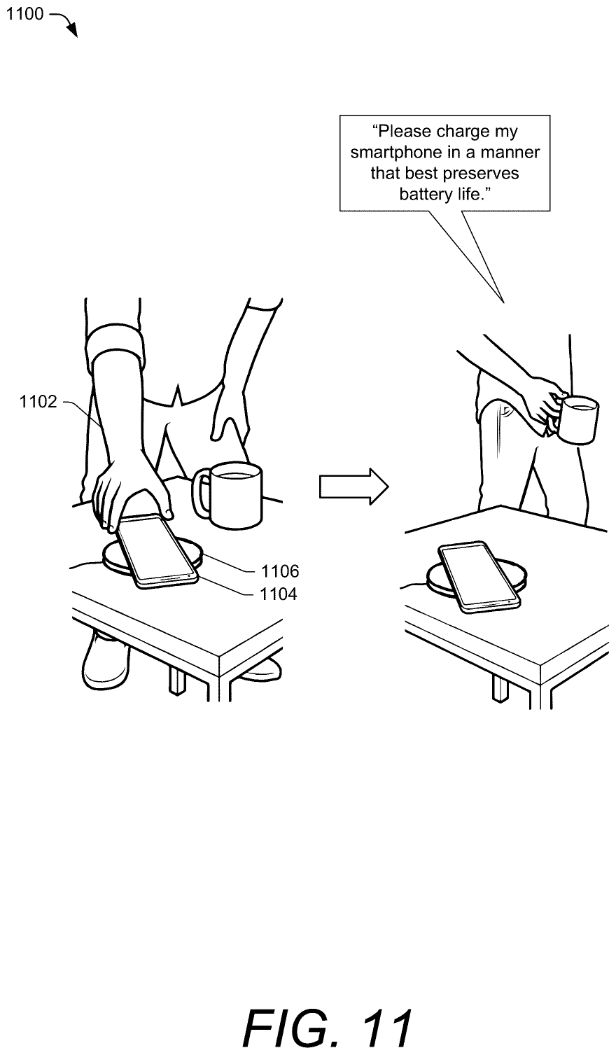

FIG. 11 illustrates another example implementation 1100 of battery management and optimization using voice integration systems in accordance with some implementations. As illustrated, a user 1102 positions a smartphone 1104 on a wireless charging unit 1106. In response to the user 1102 positioning the smartphone 1104 on the wireless charging unit 1106, the server system may determine an intent to charge the smartphone 1104. Based on one or more settings, including a previously defined (e.g., by the user 1102, by an algorithm) user preference, the smartphone 1004 may not provide an audio inquiry. For example, the user 1102 may have previously defined a user preference that configures the smartphone 1104 to cease charging at 80%. In another example, a machine-learned model may determine a desired charge level based on recent and consistent requested audio input(s).

Further illustrated, the user 1102 may provide a voice command requesting, “Please charge my smartphone in a manner that best preserves battery life.” A microphone of one or more electronic devices associated with a voice integration system may receive the voice command and transmit it, or instructions associated with the voice command, to the server system. The server system may instruct the smartphone 1104, the wireless charging unit 1106, and/or an electrical outlet coupled to the wireless charging unit 1106 to charge the smartphone 1104 in a fashion that optimally preserves battery longevity. For example, the server system can instruct the wireless charging unit 1106 to charge the smartphone 1104 at a slow rate, minimizing heat generation, over-potential, or gas formation. In another implementation, the wireless charging unit 1106 may charge the smartphone 1104 at variable rates (e.g., step profile, step charge). For example, between threshold values, the server system may instruct the smartphone 1104, the wireless charging unit 1106, and/or an electrical outlet coupled to the wireless charging unit 1106 to charge the smartphone at a first rate. Outside the threshold values (e.g., above 80%, below 20%), the server system may instruct the smartphone 1104, the wireless charging unit 1106, and/or an electrical outlet coupled to the wireless charging unit 1106 to charge at a second, slower rate.

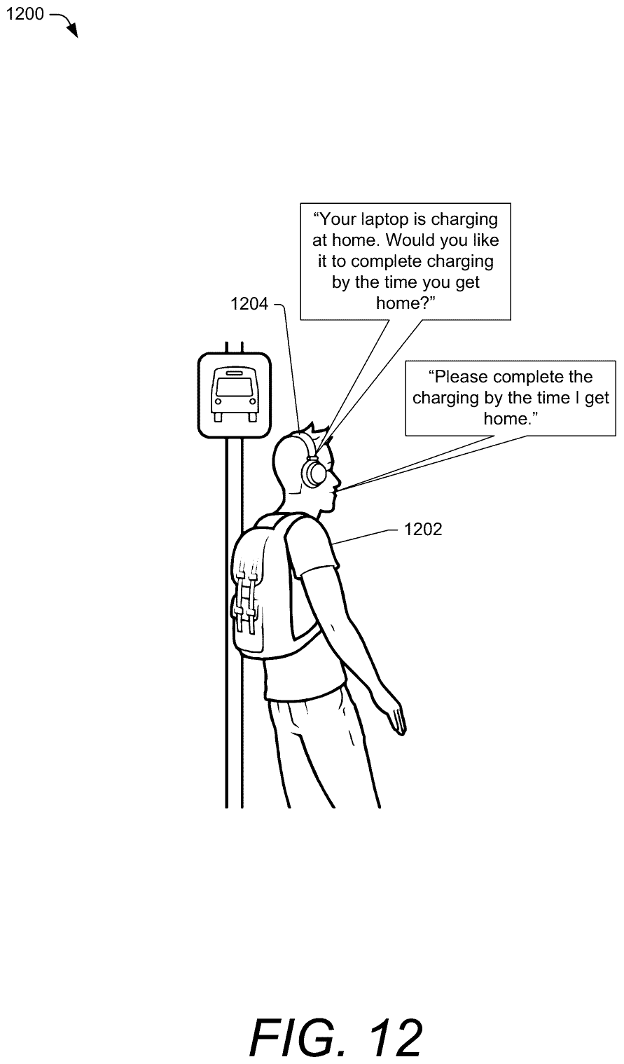

FIG. 12 illustrates another example implementation 1200 of battery management and optimization using voice integration systems in accordance with some implementations. As illustrated, a user 1202 wearing headphones 1204 is outside of a range of a HAN. In implementations, the headphones 1204 may be wirelessly connected to a wireless network device (e.g., a smartphone) that is connected to an external network (e.g., external network 108). In additional implementations, the headphones 1204 may be wirelessly connected directly to the external network. The server system, based on any of a schedule of the user 1202, device data, a routine of the user 1202, and/or one or more internet-accessible resources indicating, for example, public transportation times, weather patterns, and so on, can provide an audio inquiry to the user 1202 through the external network and speakers in the headphones 1204. In the illustrated example implementation 1200, the headphones 1204, having a speaker, a microphone, and a network communication module, may define the voice integration system.

Further illustrated, the server system may direct the headphones 1204 to provide an audio inquiry asking, “Your laptop is charging at home. Would you like to complete charging by the time you get home?” In implementations, an audio inquiry, such as the one illustrated in FIG. 12, may be provided if the server system determines, for example, that the user may have a particular need to use a specific electronic device. The user 1202 may respond, “Please complete charging by the time I get home.” In such a scenario, the server system may instruct the laptop, a charging unit, or an electrical outlet operatively coupled to the charging unit to alter a charging rate, start charging at a specific time, or finish charging at a specific time. For example, the server system may instruct the charging unit to increase a charging rate to charge the laptop quicker. In another example, the server system may instruct the charging unit to decrease a charging rate to reach a desired charge level as soon as the user 1202 arrives home.

Using the techniques described herein, users of electronic devices can procure greater levels of knowledge concerning rechargeable battery operability using voice control. In addition, control over rechargeable batteries is easily accessible to all users. As a result, rechargeable batteries can be managed and optimized more effectively, assisting in the reduction of worldwide waste and power management. In addition to the above descriptions, electronic device safety as it relates to battery operability can be improved. For example, rechargeable battery degradation-related impairments in response to subpar battery management can be reduced. Although techniques have been described herein relating to rechargeable battery management, the techniques are also extendable to other power systems that may not use rechargeable batteries. For example, systems that connect directly to an electrical outlet or grid may benefit from the techniques described herein by minimizing power expenditure using voice control.

Throughout this document, examples are described where an electronic device or electronic system (e.g., the server system, a smart device, a wireless network device) may analyze information (e.g., calendar data, location data) associated with a user, for example, the device data mentioned with respect to FIG. 5. Further to the descriptions above, a user may be provided with controls allowing the user to make an election as to both if and when systems, programs, and/or features described herein may enable collection of information (e.g., information about a user's social network, social actions, social activities, profession, a user's preferences, a user's current location), and if the user is sent content or communications from a server. The computing system can be configured to only use the information after the computing system receives explicit permission from the user of the computing system to use the data. For example, in situations where a module of the server system analyzes calendar data or location data to determine an activity of a user for context- relevant interaction between a user and the voice integration system, individual users may be provided with an opportunity to provide input to control whether programs or features of the electronic devices or electronic systems can collect and make use of the data. Further, individual users may have constant control over what programs can or cannot do with the information. In addition, information collected may be pre-treated in one or more ways before it is transferred, stored, or otherwise used, so that personally-identifiable information is removed. For example, before an electronic device shares sensor data with another electronic device (e.g., to train a model executing at another device), the electronic device may pre-treat the sensor data to ensure that any user-identifying information or device-identifying information embedded in the data is removed. In another example, a user's identity may be treated so that no personally identifiable information can be determined for the user, or a user's geographic location may be generalized where location information is obtained (for example, to a city, ZIP code, or state level) so that a particular location of a user cannot be determined. Thus, the user may have control over whether information is collected about the user and the user's device, and how such information, if collected, may be used by the computing device and/or a remote computing system.

Although systems and techniques for battery management and optimization via voice integration systems are described, it is to be understood that the subject of the appended Claims is not necessarily limited to the specific features or methods described. Rather, the specific features and methods are disclosed as example implementations and reference is made to the operating environment by way of example only.

### Additional Examples

In the following section, additional examples are provided.

Example 1: A method comprising: providing, via a speaker of a voice integration system, an audio inquiry requesting audio input from a user, the audio inquiry relating to one or more charging options for a rechargeable battery of an electronic device; receiving, from the user and at a microphone of the voice integration system, the requested audio input, the requested audio input selecting at least one of the one or more charging options; and causing the electronic device to be charged according to the selected one of the one or more charging options.

Example 2: The method as described in example 1, further comprising: determining, prior to providing the audio inquiry, a charge level of the rechargeable battery of the electronic device; and providing, based on the determined charge level of the rechargeable battery, an audio alert via the speaker at the voice integration system, the audio alert pertaining to the charge level for the rechargeable battery.

Example 3: The method as described in any of the previous examples, wherein the determined charge level for the rechargeable battery is near or less than a first threshold charge level, the first threshold charge level being associated with a battery state of charge at which the rechargeable battery experiences a greater degree of degradation due to a high depth of discharge.

Example 4: The method as described in any of the previous examples, wherein the determined charge level of the rechargeable battery is near or greater than a second threshold charge level, the second threshold charge level being associated with a battery state of charge at which the rechargeable battery experiences a greater degree of degradation due to a low depth of discharge.

Example 5: The method as described in any of the previous examples, further comprising determining, prior to providing the audio inquiry requesting audio input from the user, a proximity of the user to a charging unit configured to charging the rechargeable battery of the electronic device, and wherein providing the audio inquiry provides the audio inquiry to the user within the proximity.

Example 6: The method as described in any of the previous examples, wherein the requested audio input is determined to select a desired charge level for the rechargeable battery of the electronic device based on voice recognition.

Example 7: The method as described in any of the previous examples, wherein the requested audio input further selects one or more of a desired charge start time, a desired charge finish time, a selected charge rate, or a desired charge duration.

Example 8: The method as described in any of the previous examples, further comprising: determining a schedule of the user, the schedule indicative of one or more events, event locations, or event durations; and determining a suggested charge level for the rechargeable battery of the electronic device based on the determined schedule of the user, and wherein providing the audio inquiry requesting audio input from the user is based on the suggested charge level for the rechargeable battery of the electronic device.

Example 9: The method as described in example 8, further comprising: determining, based at least in part on the determined schedule of the user, another electronic device associated with the determined scheduled of the user; and determining a suggested battery charge level for the other electronic device based on the determined schedule of the user; and providing another audio inquiry requesting audio input from the user, the other audio inquiry relating to another one or more charging options for another rechargeable battery of the other electronic device.

Example 10: The method as described in any of the previous examples, wherein directing the electronic device or the charging unit directs via a network communication module associated with the voice integration system and configured to communicating with the electronic device or the charging unit configured to charging the rechargeable battery of the electronic device.

Example 11: The method as described in any of the previous examples, wherein directing causes the electronic device or the charging unit configured to charging the rechargeable battery of the electronic device to charge at a variable charge rate, the variable charge rate including a slow charge rate, a medium charge rate, or a quick charge rate.

Example 12: The method as described in any of the previous examples, further comprising providing an audio message, the audio message including information pertaining to benefits or consequences associated with one of the one or more charging options for the rechargeable battery of the electronic device.

Example 13: The method as described in example 12, wherein the audio message further includes information pertaining to a battery state of health or a battery state of charge for the rechargeable battery of the electronic device.

Example 14: The method as described in any of the previous examples, further comprising maintaining, after charging the rechargeable battery of the electronic device to the desired charge level, the charge level based on a self-discharge rate.

Example 15: An electronic device comprising: one or more speaker configured to output audio; one or more microphones configured to capture audio; a network communication module configured to transmit data; and a processor configured to perform the method of any one of examples 1 to 14.

Example 16: The method as described in any of the previous examples, further comprising determining, prior to providing the audio inquiry, an intent to charge the rechargeable battery of the electronic device, the intent to charge based on one or more of an action of the user, a direction of travel of the user, a location of the user, a coupling of the electronic device to a charging unit, or a schedule of the user.

Example 17: The method as described in any of the previous examples, wherein the voice integration system comprises one or more electronic devices.

Example 18: The method as described in any of the previous examples, wherein the one or more electronic devices of the voice integration system each include a microphone or a speaker.

Example 19: The method as described in any of the previous examples, further comprising determining, prior to providing the audio inquiry, an identity of the user, the determination of the identity effective to determine an association with the electronic device.

Example 20: The method as described in any of the previous examples, wherein providing the audio inquiry is based on the determined identity of the user, and wherein providing the audio inquiry is provided to the user associated with the electronic device.

Example 21: The method as described in any of the previous examples, further comprising storing, in a database, the audio inquiry and the requested audio input indicative of one or more charging options for the rechargeable battery of the electronic device.

Example 22: The method as described in any of the previous examples, further comprising determining, in later use, one or more charging options based on the charging information stored in the database.

Example 23: The method as described in any of the previous examples, wherein directing causes the electronic device or the charging unit configured to charging the rechargeable battery of the electronic device to cease charging.

Example 24: The method as described in any of the previous examples, wherein the rechargeable battery is a lithium ion battery.

Example 25: An electronic device comprising: one or more speakers configured to output audio; one or more microphones configured to capture audio; a network communication module configured to transmit data; and a processor configured to perform the method of any one of the aforementioned examples.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although aspects of battery management and optimization using voice integration systems have been described in language specific to features and/or methods, the subject of the appended claims is not necessarily limited to the specific features or methods described. Rather, the specific features and methods are disclosed as example implementations of the techniques for battery management and optimization using voice integration systems, and other equivalent features and methods are intended to be within the scope of the appended claims. Further, various different aspects are described, and it is to be appreciated that each described aspect can be implemented independently or in connection with one or more other described aspects.

1. A method comprising:
providing, via a speaker of a voice integration system, an audio inquiry requesting audio input from a user, the audio inquiry relating to one or more charging options for a rechargeable battery of an electronic device;
receiving, from the user and at a microphone of the voice integration system, the requested audio input, the requested audio input selecting at least one of the one or more charging options; and
causing the rechargeable battery of the electronic device to be charged according to the selected one of the one or more charging options.

2. The method as described in claim 1, further comprising:
determining, prior to providing the audio inquiry, a charge level of the rechargeable battery of the electronic device; and
providing, based on the determined charge level of the rechargeable battery, an audio alert via the speaker at the voice integration system, the audio alert pertaining to the charge level for the rechargeable battery.

3. The method as described in claim 2, wherein the determined charge level for the rechargeable battery is near or less than a first threshold charge level, the first threshold charge level being associated with a battery state of charge at which the rechargeable battery experiences a greater degree of degradation due to a high depth of discharge.

4. The method as described in claim 2, wherein the determined charge level of the rechargeable battery is near or greater than a second threshold charge level, the second threshold charge level being associated with a battery state of charge at which the rechargeable battery experiences a greater degree of degradation due to a low depth of discharge.

5. The method as described in claim 1, further comprising determining, prior to providing the audio inquiry requesting audio input from the user, a proximity of the user to a charging unit configured to charge the rechargeable battery of the electronic device, and wherein providing the audio inquiry provides the audio inquiry to the user within the proximity.

6. The method as described in claim 1, wherein the requested audio input is determined to select a desired charge level for the rechargeable battery of the electronic device based on voice recognition.

7. The method as described in claim 1, wherein the requested audio input selects one or more of a desired charge start time, a desired charge finish time, a selected charge rate, or a desired charge duration.

8. The method as described in claim 1, further comprising:
determining a schedule of the user, the schedule indicative of one or more events, event locations, or event durations; and
determining a suggested charge level for the rechargeable battery of the electronic device based on the determined schedule of the user, and wherein providing the audio inquiry requesting audio input from the user is based on the suggested charge level for the rechargeable battery of the electronic device.

9. The method as described in claim 8, further comprising:
determining, based at least in part on the determined schedule of the user, another electronic device associated with the determined scheduled of the user;
determining a suggested battery charge level for the other electronic device based on the determined schedule of the user; and
providing another audio inquiry requesting audio input from the user, the other audio inquiry relating to another one or more charging options for another rechargeable battery of the other electronic device.

10. The method as described in claim 1, wherein the causing the rechargeable battery of the electronic device to be charged includes directing, through a network communication module associated with the voice integration system and configured to communicate with the electronic device or a charging unit configured to charge the rechargeable battery of the electronic device, the electronic device or the charging unit to charge the rechargeable battery according to the selected one of the one or more charging options.

11. The method as described in claim 10, wherein the directing causes the electronic device or the charging unit to charge at a variable charge rate, the variable charge rate including a slow charge rate, a medium charge rate, or a quick charge rate.

12. The method as described in claim 1, further comprising providing an audio message, the audio message including information pertaining to benefits or consequences associated with the selected one of the one or more charging options for the rechargeable battery of the electronic device.

13. The method as described in claim 12, wherein the audio message further includes information pertaining to a battery state of health or a battery state of charge for the rechargeable battery of the electronic device.

14. The method as described in claim 1, further comprising maintaining, after charging the rechargeable battery of the electronic device to a desired charge level based on the selected one of the one or more charging options, the desired charge level based on a self-discharge rate.

15. An electronic device comprising:
one or more speakers configured to output audio;
one or more microphones configured to capture audio;
a network communication module configured to transmit data; and
a processor configured to:
provide, via the one or more speakers, an audio inquiry requesting audio input from a user, the audio inquiry relating to one or more charging options for a rechargeable battery of an electronic device;
receive, from the user and at the one or more microphones, the requested audio input, the requested audio input selecting at least one of the one or more charging options; and
cause the rechargeable battery of the electronic device to be charged according to the selected one of the one or more charging options.

16. The electronic device as described in claim 15, wherein the processor is further configured to:
determine, prior to provision of the audio inquiry, a charge level of the rechargeable battery of the electronic device; and
provide, based on the determined charge level of the rechargeable battery, an audio alert via the one or more speakers, the audio alert pertaining to the charge level for the rechargeable battery.

17. The electronic device as described in claim 16, wherein the determined charge level for the rechargeable battery is near or less than a threshold charge level, the threshold charge level being associated with a battery state of charge at which the rechargeable battery experiences a greater degree of degradation due to a high depth of discharge.

18. The electronic device as described in claim 16, wherein the determined charge level of the rechargeable battery is near or greater than a threshold charge level, the threshold charge level being associated with a battery state of charge at which the rechargeable battery experiences a greater degree of degradation due to a low depth of discharge.

19. The electronic device as described in claim 15, wherein the processor is further configured to:
determine, prior to the audio inquiry being provided, a proximity of the user to a charging unit configured to charge the rechargeable battery of the electronic device, and wherein the audio inquiry is provided to the user within the proximity.

20. The electronic device as described in claim 15, wherein the requested audio input is determined to select a desired charge level for the rechargeable battery of the electronic device based on voice recognition.
